(19) United States
(12) Patent Application Publication
(10) Pub. No.: US 2020/0311783 A1
(43) Pub. Date: Oct. 1, 2020

(54) PARKING LOT MANAGEMENT DEVICE, PARKING LOT MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/823,371

(22) Filed: Mar. 19, 2020

(30) Foreign Application Priority Data
Mar. 29, 2019 (JP) 2019-068247

(51) Int. Cl. G06Q 30/02; G07B 15/02; G08G 1/065; G08G 1/14; G06Q 10/02

(52) U.S. Cl. CPC G06Q 30/0284; G07B 15/02; G06Q 10/02; G08G 1/146; G08G 1/065

(57) ABSTRACT

A parking lot management device includes an acceptance unit configured to accept leaving requests for requesting movement of vehicles parked in a parking lot to a stopping area for a predetermined number of vehicles in each time slot and a recognizer configured to acquire information for recognizing a stopping situation of the vehicles in the stopping area and recognize the stopping situation of the vehicles in the stopping area on the basis of the acquired information. The acceptance unit is configured to adjust the number of vehicles whose leaving requests are accepted in a subsequent time slot on the basis of whether or not the situation of the stopping area recognized by the recognizer indicates a tendency for vehicles to stop for a time period longer than a predetermined time period.

### CROSS-REFERENCE TO RELATED APPLICATION

Priority is claimed on Japanese Patent Application No. 2019-068247, filed Mar. 29, 2019, the content of which is incorporated herein by reference.

### BACKGROUND OF THE INVENTION

### Field of the Invention

The present invention relates to a parking lot management device, a parking lot management method, and a storage medium.

### Description of Related Art

In recent years, research has been conducted on automatically controlling vehicles. In automated valet parking using this technology, technology including a configuration in which a vehicle standby space for causing a vehicle to be on standby when a passenger gets into or out of a vehicle and a passenger space for allowing the passenger to wait when the passenger gets into or out of the vehicle are disposed in a getting-into/out area and a display device for displaying whether the vehicle standby space can be currently used for waiting for getting out of the vehicle or whether the vehicle standby space is used by another vehicle for waiting for getting into the other vehicle to a driver is disposed in the vehicle standby space has been disclosed (see, for example, Japanese Unexamined Patent Application, First Publication No. 2018-145655).

However, a time period required to get into or out of a vehicle in a getting-into/out area is not taken into account in the technology disclosed in Japanese Unexamined Patent Application, First Publication No. 2018-145655.

### SUMMARY OF THE INVENTION

The present invention has been made on the basis of recognition of the above-described problems and an objective of the present invention is to provide a parking lot management device, a parking lot management method, and a storage medium capable of causing a process of getting into or out of a vehicle to be more smoothly executed at a platform.

A parking lot management device, a parking lot management method, and a storage medium according to the present invention adopt the following configurations.

(1): According to an aspect of the present invention, there is provided a parking lot management device including: an acceptance unit configured to accept leaving requests for requesting movement of vehicles parked in a parking lot to a stopping area for a predetermined number of vehicles in each time slot; and a recognizer configured to acquire information for recognizing a stopping situation of the vehicles in the stopping area and recognize the stopping situation of the vehicles in the stopping area on the basis of the acquired information, wherein the acceptance unit is configured to adjust the number of vehicles whose leaving requests are accepted in a subsequent time slot on the basis of whether or not the situation of the stopping area recognized by the recognizer indicates a tendency for vehicles to stop for a time period longer than a predetermined time period.

(2): In the above-described aspect (1), the recognizer is configured to measure a stop time period of each vehicle which is stopped in the stopping area, and the acceptance unit is configured to reduce the number of vehicles whose leaving requests are accepted in a subsequent time slot in a case where the recognizer has recognized the presence of a long-time stopped vehicle having a stop time period longer than the predetermined time period in a current time slot.

(3): In the above-described aspect (2), the recognizer is configured to measure a pre-entry stop time period in which each vehicle is stopped in the stopping area in a case where a user gets out of the vehicle, and the acceptance unit is configured to estimate the stop time period in which each vehicle is stopped in the stopping area after leaving the parking lot on the basis of the pre-entry stop time period and changes the number of vehicles whose leaving requests are accepted in each time slot on the basis of the estimated stop time period.

(4): In the above-described aspect (3), the acceptance unit is configured to provide a notification of a new time slot changed according to the recognition of the presence of the long-time stopped vehicle.

(5): In the above-described aspect (4), the parking lot management device further includes a fee calculator configured to calculate a parking fee in each vehicle, wherein the fee calculator is configured to calculate the parking fee on the basis of a predetermined scheduled time when the vehicle arrives at the stopping area without including a delay time period in a time period of a parking fee calculation target in a case where a time at which the vehicle arrives at the stopping area according to the recognition of the presence of the long-time stopped vehicle has been delayed.

(6): In the above-described aspect (5), in a case where the vehicle after leaving has arrived at the stopping area the fee calculator includes the stop time period of the vehicle in the time period of the parking fee calculation target if another vehicle to be stopped in the stopping area is present in a subsequent time slot and does not include the stop time period of the vehicle in the time period of the parking fee calculation target if another vehicle to be stopped in the stopping area is absent in the subsequent time slot.

(7): In the above-described aspect (6), the fee calculator is configured to provide a notification of whether or not a current stop time period is to be included in the time period of the parking fee calculation target.

(8): In the above-described aspect (6), the fee calculator includes a subsequent stop time period of the vehicle in the time period of the parking fee calculation target in a case where a current stop time period exceeds a predetermined time period.

(9): In the above-described aspect (8), the fee calculator excludes the subsequent stop time period of the vehicle from the time period of the parking fee calculation target in a case where the vehicle is a vehicle satisfying a handicap condition and the current stop time period exceeds the predetermined time period.

(10): According to an aspect of the present invention, there is provided a parking lot management method using a computer including: accepting, by a computer of a parking lot management device, leaving requests for requesting movement of vehicles parked in a parking lot to a stopping area for a predetermined number of vehicles in each time slot; acquiring information for recognizing a stopping situation of the vehicles in the stopping area and recognizing the stopping situation of the vehicles in the stopping area on the basis of the acquired information; and adjusting the number of vehicles whose leaving requests are accepted in a subsequent time slot on the basis of whether or not the recognized situation of the stopping area indicates a tendency for vehicles to stop for a time period longer than a predetermined time period.

(11): According to an aspect of the present invention, there is provided a computer-readable non-transitory storage medium storing a program for causing a computer of a parking lot management device to: accept leaving requests for requesting movement of vehicles parked in a parking lot to a stopping area for a predetermined number of vehicles in each time slot; acquire information for recognizing a stopping situation of the vehicles in the stopping area and recognize the stopping situation of the vehicles in the stopping area on the basis of the acquired information; and adjust the number of vehicles whose leaving requests are accepted in a subsequent time slot on the basis of whether or not the recognized situation of the stopping area indicates a tendency for vehicles to stop for a time period longer than a predetermined time period.

According to the above-described aspects (1) to (11), it is possible to cause a process of getting into or out of a vehicle to be more smoothly executed at a platform.

### BRIEF DESCRIPTION OF THE DRAWINGS

FIG. 1 is a configuration diagram of a vehicle system including a vehicle control device mounted on a vehicle using a parking lot to which a parking lot management device according to an embodiment is applied.

FIG. 2 is a functional configuration diagram of a first controller and a second controller.

FIG. 3 is a diagram schematically showing a scene in which an autonomous parking event is executed.

FIG. 4 is a diagram showing an example of a configuration of the parking lot management device according to the embodiment.

FIG. 5 is a flowchart showing an example of a flow of a leaving request acceptance process to be executed by an acceptance unit.

FIG. 6 is a flowchart showing an example of a flow of a process of changing a time slot in which a leaving request has been accepted to be executed by the acceptance unit.

FIG. 7 is a flowchart showing an example of a flow of a process of changing a time period of a parking fee calculation target to be executed by a recognizer.

FIG. 8 is a diagram schematically showing a scene in which it is necessary to change a time slot in which the acceptance unit accepts a leaving request.

FIG. 9 is a diagram showing an example of a leaving table in which an accepted leaving request is assigned to a time slot.

FIG. 10 is a diagram showing an example of a leaving table in which a time slot for accepting a leaving request is changed according to the presence of a long-time stopped vehicle.

FIG. 11 is a diagram showing an example of a leaving table in which a time slot is changed according to the presence of a long-time stopped vehicle.

FIG. 12 is a diagram showing an example of a hardware configuration of a controller according to the embodiment.

### DETAILED DESCRIPTION OF THE INVENTION

Embodiments of a parking lot management device, a parking lot management method, and a storage medium of the present invention will be described below with reference to the drawings. Although a case in which left-hand traffic regulations are applied will be described, it is only necessary to reverse the left and right when right-hand traffic regulations are applied.

### [Overall Configuration Example of Vehicle System 1]

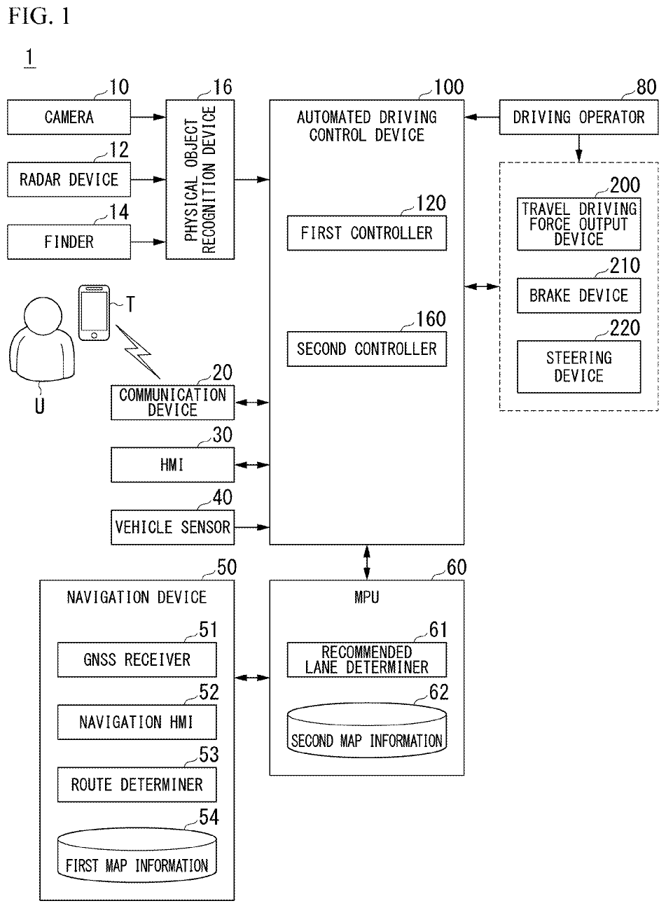

FIG. 1 is a configuration diagram of a vehicle system 1 including a vehicle control device mounted on a vehicle using a parking lot to which a parking lot management device according to an embodiment is applied. A vehicle equipped with the vehicle system 1 is, for example, a vehicle such as a two-wheeled vehicle, a three-wheeled vehicle, or a four-wheeled vehicle, and a driving source thereof is an internal combustion engine such as a diesel engine or a gasoline engine, an electric motor, or a combination thereof. The electric motor operates using electric power generated by a power generator connected to the internal combustion engine, or discharge power of a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example, a part of the configuration may be omitted, and another configuration may be further added.

For example, the camera 10 is a digital camera using a solid-state imaging element such as a charge coupled device (CCD) or a complementary metal oxide semiconductor (CMOS). The camera 10 is attached to any position on the vehicle (hereinafter, a vehicle M) on which the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position (a distance to and a direction) of a physical object by detecting radio waves (reflected waves) reflected by the physical object. The radar device 12 is attached to any position on the vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the vehicle M and measures scattered light. The finder 14 detects a distance to an object on the basis of time from light emission to light reception. The radiated light is, for example, pulsed laser light. The finder 14 is attached to any position on the vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 1.

The communication device 20 communicates with a terminal (hereinafter, a user terminal T) used by a user U of the vehicle M and another vehicle or a parking lot management device (to be described below) present in the vicinity of the vehicle M or various types of server devices using, for example, a cellular network or a Wi-Fi network, Bluetooth (registered trademark), dedicated short range communication (DSRC), or the like.

The HMI 30 presents various types of information to the occupant of the vehicle M and receives an input operation of the occupant. The HMI 30 includes various types of display devices, a speaker, a buzzer, a touch panel, a switch, keys, and the like.

The vehicle sensor 40 includes a vehicle speed sensor configured to detect the speed of the vehicle M, an acceleration sensor configured to detect acceleration, a yaw rate sensor configured to detect an angular speed around a vertical axis, a direction sensor configured to detect a direction of the vehicle M, and the like.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of a signal received from a GNSS satellite. The position of the vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal (for example, the user terminal T) possessed by the occupant. The navigation device 50 may transmit a current position and a destination to a navigation server via the communication device 20 and acquire a route equivalent to the route on the map from the navigation server.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines what number lane the vehicle travels in from the left. The recommended lane determiner 61 determines the recommended lane so that the vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/zip code), facility information, telephone number information, and the like. The second map information 62 may be updated at any time when the communication device 20 communicates with another device.

For example, the driving operator 80 includes an accelerator pedal, a brake pedal, a shift lever, a steering wheel, a steering wheel variant, a joystick, and other operation elements. A sensor configured to detect an amount of operation or the presence or absence of an operation is attached to the driving operator 80, and a detection result thereof is output to the automated driving control device 100 or some or all of the travel driving force output device 200, the brake device 210, and the steering device 220.

The automated driving control device 100 includes, for example, a first controller 120 and a second controller 160. The first controller 120 and the second controller 160 are implemented, for example, by a hardware processor such as a central processing unit (CPU) executing a program (software). Some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage device such as an HDD or a flash memory of the automated driving control device 100 (a storage device including a non-transitory storage medium) or may be installed in the HDD or the flash memory of the automated driving control device 100 when the program is stored in a removable storage medium such as a DVD or a CD-ROM and the storage medium (the non-transitory storage medium) is mounted in a drive device.

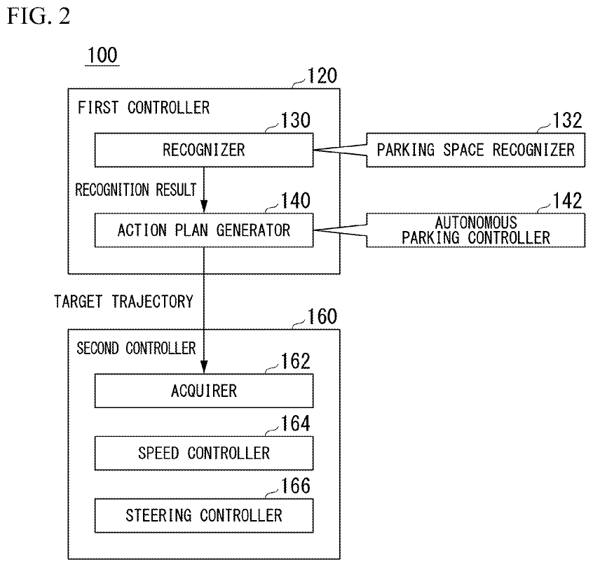

FIG. 2 is a functional configuration diagram of the first controller 120 and the second controller 160. The first controller 120 includes, for example, a recognizer 130 and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured.

The recognizer 130 recognizes a state such as a position, velocity, or acceleration of a physical object present in the vicinity of the vehicle M on the basis of information input from the camera 10, the radar device 12, and the finder 14 via the physical object recognition device 16. For example, the position of the physical object is recognized as a position on absolute coordinates with a representative point (a center of gravity, a driving shaft center, or the like) of the vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the recognizer 130 recognizes a lane in which the vehicle M is traveling (a travel lane). For example, the recognizer 130 recognizes the travel lane by comparing a pattern of a road dividing line (for example, an arrangement of solid lines and broken lines) obtained from the second map information 62 with a pattern of road dividing lines in the vicinity of the vehicle M recognized from an image captured by the camera 10. The recognizer 130 may recognize a travel lane by recognizing a traveling path boundary (a road boundary) including a road dividing line, a road shoulder, a curb stone, a median strip, a guardrail, or the like as well as a road dividing line. In this recognition, a position of the vehicle M acquired from the navigation device 50 or a processing result of the INS may be added. The recognizer 130 recognizes a temporary stop line, an obstacle, red traffic light, a toll gate, and other road events.

When the travel lane is recognized, the recognizer 130 recognizes a position or orientation of the vehicle M with respect to the travel lane. For example, the recognizer 130 may recognize a gap of a reference point of the vehicle M from the center of the lane and an angle formed with respect to a line connecting the center of the lane in the travel direction of the vehicle M as a relative position and orientation of the vehicle M related to the travel lane. Alternatively, the recognizer 130 may recognize a position of the reference point of the vehicle M related to one side end portion (a road dividing line or a road boundary) of the travel lane or the like as a relative position of the vehicle M related to the travel lane.

The recognizer 130 includes a parking space recognizer 132 to be activated in an autonomous parking event to be described below. Details of the function of the parking space recognizer 132 will be described below.

The action plan generator 140 generates a future target trajectory along which the vehicle M automatedly travels so that the vehicle M can generally travel in the recommended lane determined by the recommended lane determiner 61 and further cope with a surrounding situation of the vehicle M. For example, the target trajectory includes a speed element. For example, the target trajectory is represented by sequentially arranging points (trajectory points) at which the vehicle M is required to arrive. The trajectory point is a point where the vehicle M is required to reach for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the vehicle M is required to arrive at the sampling time for each predetermined sampling time. In this case, information about the target speed or the target acceleration is represented by an interval between the trajectory points.

The action plan generator 140 may set an automated driving event when the target trajectory is generated. The automated driving event includes a constant-speed traveling event, a low-speed following event, a lane change event, a branching event, a merging event, a takeover event, an autonomous parking event in which a vehicle is parked according to unmanned traveling in valet parking or the like, and the like. The action plan generator 140 generates a target trajectory according to an activated event. The action plan generator 140 includes an autonomous parking controller 142 to be activated when the autonomous parking event is executed. Details of the function of the autonomous parking controller 142 will be described below.

The second controller 160 controls the travel driving force output device 200, the brake device 210, and the steering device 220 so that the vehicle M passes along the target trajectory generated by the action plan generator 140 at a scheduled time.

Returning to FIG. 2, the second controller 160 includes, for example, an acquirer 162, a speed controller 164, and a steering controller 166. The acquirer 162 acquires information of a target trajectory (a trajectory point) generated by the action plan generator 140 and causes the acquired information to be stored in a memory (not shown). The speed controller 164 controls the travel driving force output device 200 or the brake device 210 on the basis of speed elements associated with the target trajectory stored in the memory. The steering controller 166 controls the steering device 220 in accordance with a degree of curve of a target trajectory stored in the memory. For example, processes of the speed controller 164 and the steering controller 166 are implemented by a combination of feed-forward control and feedback control. As one example, the steering controller 166 executes feed-forward control according to the curvature of the road in front of the vehicle M and feedback control based on a deviation from the target trajectory in combination.

The travel driving force output device 200 outputs a travel driving force (torque) for driving the vehicle to the drive wheels. The travel driving force output device 200 includes, for example, a combination of an internal combustion engine, an electric motor, a transmission, and the like, and an electronic control unit (ECU) that controls these components. The ECU controls the above-described components in accordance with information input from the second controller 160 or information input from the driving operator 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operator 80 so that brake torque according to a braking operation is output to each wheel. The brake device 210 may include a mechanism configured to transfer the hydraulic pressure generated by an operation of the brake pedal included in the driving operator 80 to the cylinder via a master cylinder as a backup. Also, the brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor to change the direction of the steerable wheels in accordance with the information input from the second controller 160 or the information input from the driving operator 80.

### [Autonomous Parking Event-Time of Entering]

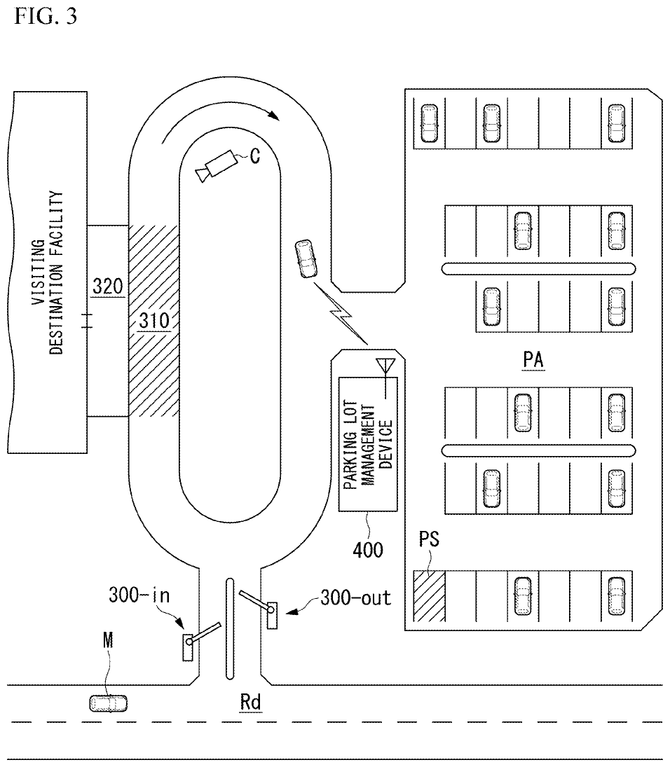

For example, the autonomous parking controller 142 causes the vehicle M to be parked within a parking space on the basis of information acquired from the parking lot management device 400 by the communication device 20. FIG. 3 is a diagram schematically showing a scene in which an autonomous parking event is executed. In the following description, a case in which a valet parking scheme is adopted in a part or all of a parking lot PA will be described. The user U (occupant) of the vehicle M selects whether the vehicle M enters a valet parking type parking lot or a manual parking type parking lot before a parking lot is used. When the vehicle M enters the manual parking type parking lot, the user U is in the vehicle M until the vehicle M arrives at a parking space PS. When the vehicle M leaves the manual parking type parking lot, the user U moves to the parking space PS on his/her own and causes the vehicle M to depart therefrom after getting into the vehicle M. On the other hand, when the vehicle M enters the valet parking type parking lot, the user U causes the vehicle M to be stopped at a dedicated position (hereinafter, a stopping area 310) before the parking space and gets out of the vehicle M using a getting-into/out area 320 adjacent to the stopping area 310. When the vehicle M has entered the valet parking type parking lot, the user U gets into the vehicle M using the getting-into/out area 320 as in the case when the user U gets out of the vehicle M. A method of parking (entering) of the vehicle M after the user U gets out of the vehicle M in the valet parking type parking lot will be described below. A combination of the stopping area 310 and the getting-into/out area 320 is an example of a “platform”.

Gates 300-in and 300-out are provided on a route from a road Rd shown in FIG. 3 to a visiting destination facility. The vehicle M moves to the stopping area 310 after passing through the gate 300-in according to manual driving or automated driving. The stopping area 310 faces the getting-into/out area 320 connected to the visiting destination facility. The getting-into/out area 320 is provided with eaves for avoiding rain and snow. A dedicated getting-into area and a dedicated getting-out area may be set in the getting-into/out area 320 and the dedicated getting-into area and the dedicated getting-out area may be changed in accordance with the presence or the number of users who want to use the getting-into/out area 320. In the following description, a case in which a fixed dedicated getting-into area and a fixed dedicated getting-out area are not particularly provided in the getting-into/out area 320 and the getting-into/out area 320 is shared for use by a user who gets into a vehicle and a user who gets out of a vehicle will be described. As shown in FIG. 3, a camera C for imaging the stopping area 310 is provided. The camera C is, for example, a digital camera using a solid-state imaging device such as a CCD or a CMOS, and transmits periodically captured images to the parking lot management device 400. The images periodically transmitted by the camera C is used as information for the parking lot management device 400 to recognize a stopping situation of vehicles in the stopping area 310. The camera C is an example of a means for acquiring “information for recognizing a stopping situation of vehicles”.

After an occupant gets out of the vehicle M in the stopping area 310, the vehicle M performs automated driving in an unmanned manner and starts an autonomous parking event in which the vehicle M moves to the parking space PS within the parking lot PA. A start trigger of the autonomous parking event may be, for example, any operation of the occupant or may be a predetermined signal wirelessly received from the parking lot management device 400. When the autonomous parking event starts, the autonomous parking controller 142 controls the communication device 20 so that the communication device 20 transmits a parking request to the parking lot management device 400. The vehicle M moves from the stopping area 310 to the parking lot PA in accordance with the guidance of the parking lot management device 400 or while performing sensing on its own.

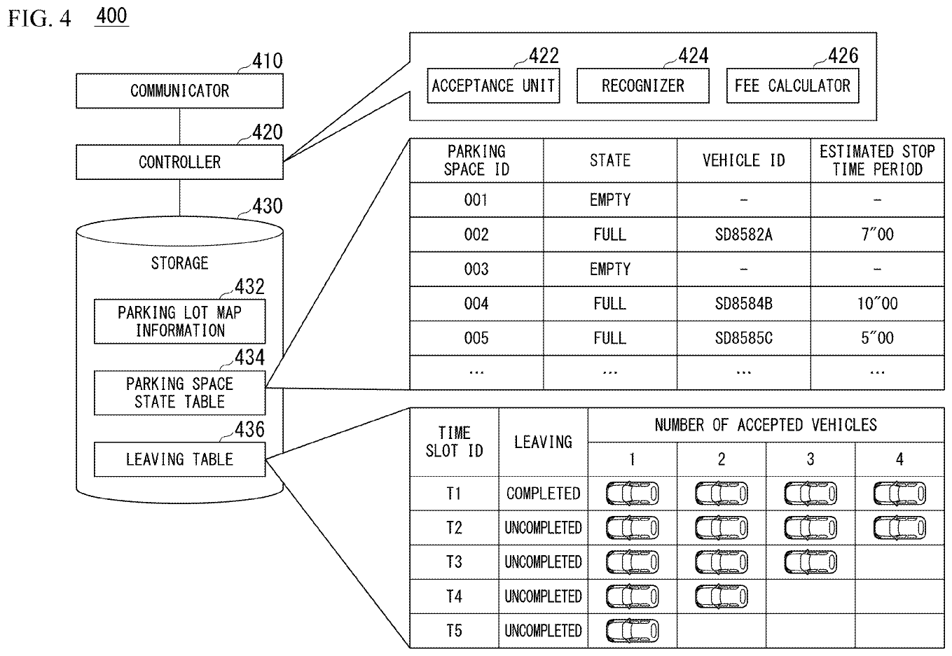

FIG. 4 is a diagram showing an example of a configuration of the parking lot management device 400 according to the embodiment. The parking lot management device 400 includes, for example, a communicator 410, a controller 420, and a storage 430. The controller 420 includes, for example, an acceptance unit 422, a recognizer 424, and a fee calculator 426. The storage 430 stores information such as parking lot map information 432, a parking space state table 434, and a leaving table 436.

The communicator 410 wirelessly communicates with the vehicle M and other vehicles. The controller 420 guides the vehicle to the parking space PS on the basis of the information acquired by the communicator 410 and the information stored in the storage 430. The parking lot map information 432 is information geometrically indicating a structure of the parking lot PA. The parking lot map information 432 includes coordinates for each parking space PS. In the parking space state table 434, for example, a state which is an empty state or a full (parked) state, a vehicle ID which is identification information of a vehicle during parking in the case of the full state, and an estimated stop time period in which the vehicle will be stopped in the stopping area 310 after leaving are associated with a parking space ID which is identification information of the parking space PS. In the leaving table 436, for example, a state indicating whether or not leaving of all vehicles whose leaving requests have been assigned to a time slot has been completed with respect to a time slot ID which is identification information of the time slot and the number of accepted vehicles indicating the number of vehicles whose leaving requests have been accepted in the time slot are associated with a time slot ID which is identification information of the time slot.

When the communicator 410 receives a parking request from the vehicle, the controller 420 extracts a parking space PS whose state is an empty state with reference to the parking space state table 434, acquires a position of the extracted parking space PS from the parking lot map information 432, and transmits a suitable route to the acquired position of the parking space PS to the vehicle using the communicator 410. The controller 420 instructs a specific vehicle to stop or slow down as necessary on the basis of a positional relationship of a plurality of vehicles so that the vehicles do not move to the same position at the same time.

In the vehicle receiving the route (hereinafter referred to as the vehicle M), the autonomous parking controller 142 generates a target trajectory based on the route. When the vehicle M approaches the target parking space PS, the parking space recognizer 132 recognizes parking slot lines that partition the parking space PS and the like, recognizes a detailed position of the parking space PS, and provides the recognized position to the autonomous parking controller 142. The autonomous parking controller 142 receives the provided position to correct the target trajectory and cause the vehicle M to be parked in the parking space PS.

The communicator 410 receives images periodically transmitted by the camera C. The recognizer 424 of the controller 420 recognizes the vehicle M stopped in the stopping area 310 on the basis of each of the received images and measures a time period in which a door of the vehicle M is in an open state as a stop time period before entry (hereinafter, a pre-entry stop time period) required for the user U of the vehicle M to get out of the vehicle M. The recognizer 424 may measure a time period from the time when the vehicle M is stopped in the stopping area 310 to the time when the communicator 410 receives the parking request from the vehicle M as the pre-entry stop time period. The acceptance unit 422 of the controller 420 estimates the stop time period during which the vehicle M is stopped in the stopping area 310 after leaving, i.e., a stop time period after leaving (hereinafter, a post-leaving stop time period) required for the user U to get into the vehicle M, on the basis of the pre-entry stop time period measured by the recognizer 424. The acceptance unit 422 records the estimated post-leaving stop time period as an estimated stop time period in the parking space state table 434 in association with a parking space ID to which the vehicle M has been guided. Here, the estimated stop time period recorded in the parking space state table 434 is referred to when the acceptance unit 422 receives a leaving request for requesting automated movement of the vehicle M to the stopping area after leaving.

### [Autonomous Parking Event-Time of Leaving]

The autonomous parking controller 142 and the communication device 20 maintain the operating state also when the vehicle M has been parked. The autonomous parking controller 142 causes the system of the vehicle M to be activated and causes the vehicle M to move to the stopping area 310, for example, when the communication device 20 has received a pick-up request from the terminal device (the user terminal T) of the occupant. At this time, the autonomous parking controller 142 controls the communication device 20 so that the communication device 20 transmits a leaving request for requesting the guidance of movement from the parking space PS where the vehicle has currently been parked to the stopping area 310 to the parking lot management device 400. When the leaving request transmitted by the autonomous parking controller 142 is accepted and leaving starts, the controller 420 of the parking lot management device 400 instructs a specific vehicle to stop or slow down as necessary on the basis of a positional relationship of a plurality of vehicles so that the vehicles do not move to the same position at the same time as in the entering process. When the vehicle M is moved to the stopping area 310 and the occupant is allowed to get into the vehicle M, the autonomous parking controller 142 stops the operation and the manual driving or the automated driving by another functional unit is subsequently started.

The autonomous parking controller 142 may find an empty parking space on its own on the basis of a detection result of the camera 10, the radar device 12, the finder 14, or the physical object recognition device 16 independently of communication and cause the vehicle M to be parked within the found parking space without being limited to the above description.

The parking lot management device 400 manages the number of leaving vehicles for every predetermined time slot (for example, every 15 [min]) so that the vehicles parked in the parking space PS within the parking lot PA do not leave the parking space PS at the same time to prevent the vehicles from being concentrated on the stopping area 310. That is, the parking lot management device 400 manages the number of vehicles that leave the parking space at the same time to prevent a situation in which traffic congestion occurs in the stopping area 310 due to congestion of the stopping area 310. When the communicator 410 receives a leaving request from any vehicle, the acceptance unit 422 of the controller 420 searches for a time slot in which leaving is possible with reference to the leaving table 436 and accepts leaving of a vehicle transmitting a current leaving request in a time slot in which the number of accepted vehicles is less than the predetermined number of vehicles. That is, the acceptance unit 422 sequentially assigns the accepted leaving requests to the time slots in the order in which the leaving requests transmitted by the vehicles have been received. For example, the parking lot management device 400 can directly receive a leaving request in which a time slot after a predetermined time period (for example, a time slot after two hours) has been designated transmitted by the user terminal T and accept the leaving request as a reservation of a leaving time slot in advance. In this case, the acceptance unit 422 accepts a reservation of leaving of a corresponding vehicle in the time slot designated in the received leaving request. FIG. 4 shows an example of the leaving table 436 in which the number of vehicles accepted in each time slot is four. In the example of the leaving table 436 shown in FIG. 4, for example, the vehicle initially accepted in the time slot of the time slot ID=T5 is a vehicle of a previously reserved leaving request. Although the number of vehicles whose leaving requests have been accepted is represented by arranging and displaying characters representing vehicles in a field of the number of accepted vehicles in each time slot ID in the example of the leaving table 436 shown in FIG. 4, information such as a parking space ID and a vehicle ID recorded in the parking space state table 434 may be arranged in the field of the number of accepted vehicles. In this case, the vehicles that leave in each time slot can be individually identified by means of the leaving table 436.

The recognizer 424 of the controller 420 recognizes a stopping situation of vehicles in the stopping area 310 on the basis of an image from the camera C received by the communicator 410 when the acceptance unit 422 accepts the leaving request. The recognizer 424 recognizes a vehicle leaving the parking space and stopped in the stopping area 310, and measures a time period in which a door of the vehicle is in an open state as a stop time period required for the user U of the vehicle to get into the vehicle, i.e., an actual post-leaving stop time period, on the basis of the received image as in the measurement of the pre-entry stop time period. The recognizer 424 may measure a time period from the time when the leaving vehicle is stopped in the stopping area 310 to the time when the leaving vehicle departs from the stopping area 310 as the actual post-leaving stop time period. At this time, when the measured post-leaving stop time period is longer than a predetermined time period, i.e., when the vehicle has been stopped in the stopping area 310 for a long time, the recognizer 424 recognizes the vehicle as a long-time stopped vehicle.

The acceptance unit 422 updates the leaving table 436 while accepting a currently received leaving request in a latest time slot in which the number of accepted vehicles is less than a limit when a stopping situation of vehicles in the stopping area 310 recognized by the recognizer 424 is a situation in which leaving of the vehicle transmitting a current leaving request is possible such as a situation in which all leaving vehicles have departed from the stopping area 310 in a time slot in which leaving has already been completed. On the other hand, the acceptance unit 422 updates the leaving table 436 while accepting a currently received leaving request in a subsequent time slot also when there is a latest time slot in which the number of accepted vehicles is less than the limit if a stopping situation of vehicles in the stopping area 310 recognized by the recognizer 424 is a situation in which leaving vehicles have been stopped in a time slot in which leaving has already been completed, i.e., a situation in which there is a long-time stopped vehicle in the stopping area 310. At this time, the acceptance unit 422 refers to the parking space state table 434 and adjusts a time slot in which a currently received leaving request is accepted or the number of accepted vehicles on the basis of the long-time stopped vehicle stopped in the stopping area 310 or an estimated stop time period associated with a vehicle transmitting a current leaving request. For example, when it is estimated that the long-time stopped vehicle stopped in the stopping area 310 is about to depart therefrom, the acceptance unit 422 accepts the currently received leaving request in the latest time slot in which the number of accepted vehicles is less than the limit. For example, when it is estimated that the long-time stopped vehicle stopped in the stopping area 310 will not depart therefrom for a while, the acceptance unit 422 reduces the number of accepted vehicles whose leaving requests are accepted in the latest time slot or a time slot until the estimated stop time period elapses. For example, when a vehicle transmitting the current leaving request is estimated to be a long-time stopped vehicle, the acceptance unit 422 reduces the number of accepted vehicles whose leaving requests are accepted in the time slot until the estimated stop time period elapses after the current leaving request was accepted.

The acceptance unit 422 controls the communicator 410 so that the communicator 410 notifies the autonomous parking controller 142 of information of a time slot in which the leaving request has been accepted. Thereby, the autonomous parking controller 142 controls the communication device 20 so that the communication device 20 transmits the information of the time slot provided through the notification from the parking lot management device 400 to the user terminal T and allows the user U to know the information.

The stopping situation of vehicles in the stopping area 310 is assumed to be changed sequentially. Thus, a case in which it is ascertained that a vehicle leaving the parking space in a previous time slot is still stopped when each vehicle leaving the parking space in a current time slot arrives at the stopping area 310 while the vehicle whose leaving request has been accepted by the acceptance unit 422 in the current time slot leaves the parking space and goes to the stopping area 310 is also conceivable. In this case, the acceptance unit 422 is configured to eliminate a situation in which it is necessary for a vehicle already leaving the parking space to be on standby before the stopping area 310, i.e., a situation in which traffic congestion occurs in the stopping area 310, at the earlier stage by making a change so that a vehicle whose leaving request has been accepted in a time slot in which leaving is not completed leaves in a subsequent time slot. In this case, the acceptance unit 422 also provides a notification to the autonomous parking controller 142 of the vehicle whose time slot has been changed.

### [Calculation of Parking Fee]

The parking lot management device 400 is configured to calculate a parking fee for the vehicle parked in each parking space PS within the parking lot PA. At this time, the fee calculator 426 of the controller 420 changes a target time period when the parking fee is calculated in accordance with a situation when the acceptance unit 422 has accepted the leaving request transmitted by each vehicle, a stopping situation of vehicles in the stopping area 310 after leaving recognized by the recognizer 424, or the like.

For example, although the fee calculator 426 normally sets a time period during which the vehicle is parked in the parking space PS as a time period of a parking fee calculation target, a time period until a predetermined time slot is set as the time period of the parking fee calculation target with respect to a leaving vehicle in a time slot that is later than the predetermined time slot according to the presence of a long-time stopped vehicle in the stopping area 310. For example, the fee calculator 426 prompts the vehicle to depart from the stopping area 310 by also setting the time period in which the vehicle is stopped in the stopping area 310 as the time period of the parking fee calculation target when there is another vehicle scheduled to be stopped in the stopping area 310 after leaving the parking space in the next time slot if a leaving vehicle is stopped in the stopping area 310. On the other hand, when there is no other vehicle, the fee calculator 426 does not set the time period in which the vehicle is stopped in the stopping area 310 as the time period of the parking fee calculation target. However, in this case, the vehicle is also prompted to depart from the stopping area 310 by setting a subsequent time period as the time period of the parking fee calculation target when the stop time period in the stopping area 310 exceeds a predetermined time period.

The fee calculator 426 controls the communicator 410 so that the communicator 410 notifies the autonomous parking controller 142 of information of whether or not a time period during which the vehicle is stopped in the stopping area 310 is to be included in the time period of the parking fee calculation target. Thereby, the autonomous parking controller 142 controls the communication device 20 so that the communication device 20 transmits information about the time period of the parking fee calculation target whose notification is provided from the parking lot management device 400 to the user terminal T and allows the user U to know the information. The autonomous parking controller 142 may allow the user U to know the information about the time period of the parking fee calculation target whose notification is provided from the parking lot management device 400, using, for example, the HMI 30 or the navigation HMI 52.

### [Time Slot Assignment Process]

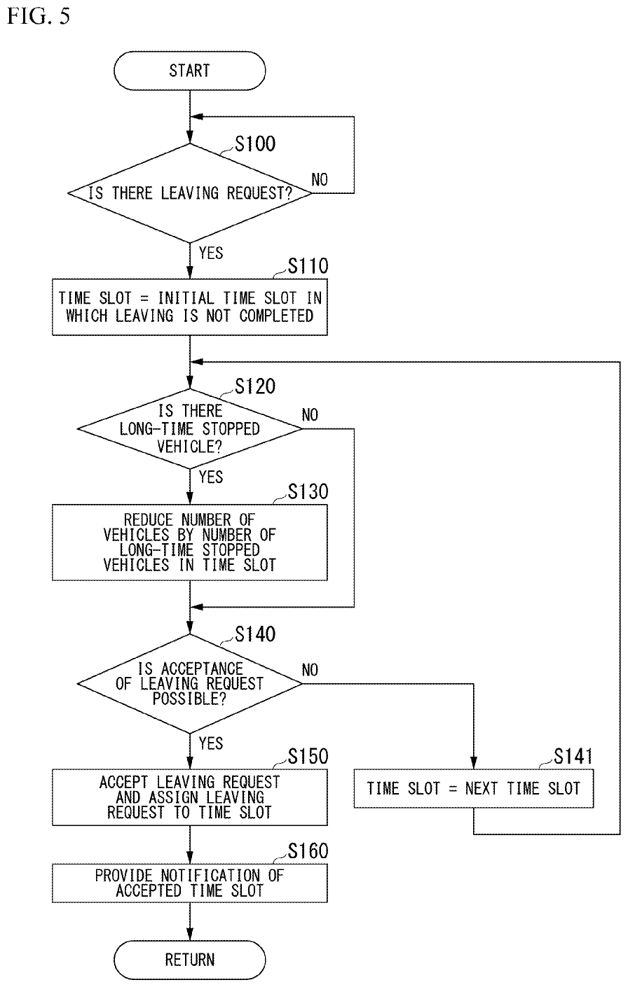

Hereinafter, a process of accepting a leaving request implemented by the acceptance unit 422 will be described. FIG. 5 is a flowchart showing an example of the flow of a process of accepting a leaving request to be executed by the acceptance unit 422. In the following description, it is assumed that the recognizer 424 receives images periodically transmitted by the camera C and recognizes a currently stopped state of vehicles in the stopping area 310.

The acceptance unit 422 checks whether or not there is a leaving request transmitted by any vehicle (step S100). When no leaving request has been transmitted from any vehicle in step S100, the acceptance unit 422 returns the process to step S100 and iteratively checks whether or not there is a leaving request transmitted by any vehicle at predetermined time intervals.

On the other hand, when there is a leaving request transmitted by any vehicle (hereinafter referred to as the vehicle M) in step S100, the acceptance unit 422 sets a time slot for accepting the leaving request to an initial time slot in which leaving is not completed (step S110). Subsequently, the acceptance unit 422 checks whether or not the recognizer 424 has recognized the presence of the long-time stopped vehicle in the current stopping area 310 on the basis of the image received from the camera C (step S120). When it is checked that there is no long-time stopped vehicle in the current stopping area 310 in step S120, the acceptance unit 422 moves the process to step S140.

On the other hand, when it is checked that there is a long-time stopped vehicle in the current stopping area 310 in step S120, the acceptance unit 422 reduces the number of vehicles whose leaving requests are accepted in a currently set time slot by the checked number of long-time stopped vehicles (step S130).

Next, the acceptance unit 422 determines whether or not the leaving request can be accepted in the currently set time slot (step S140). That is, when the number of vehicles whose leaving requests are accepted is reduced in the currently set time slot in step S130, it is also determined whether or not the leaving request currently transmitted by the vehicle M can be accepted. When it is determined that the leaving request cannot be accepted in the currently set time slot in step S140, the acceptance unit 422 sets the time slot for accepting the leaving request to the next time slot (step S141). The acceptance unit 422 returns the process to step S120 and iterates the processing of steps S120 to S140 with respect to the next time slot.

On the other hand, when it is determined that the leaving request can be accepted in the currently set time slot in step S140, the acceptance unit 422 accepts the currently received leaving request and assigns the accepted leaving request to the currently set time slot (step S150).

Next, the acceptance unit 422 notifies the vehicle M transmitting the current leaving request of information of the time slot in which the leaving request has been accepted (step S160).

As described above, the acceptance unit 422 checks the stopping situation of vehicles in the stopping area 310 recognized by the recognizer 424 each time the leaving request transmitted by any vehicle is received and iterates a process of searching for and assigning a time slot in which a currently received leaving request can be accepted. Thereby, the acceptance unit 422 can allow the user to get into the vehicle in the stopping area 310 more smoothly.

### [Time Slot Change Process]

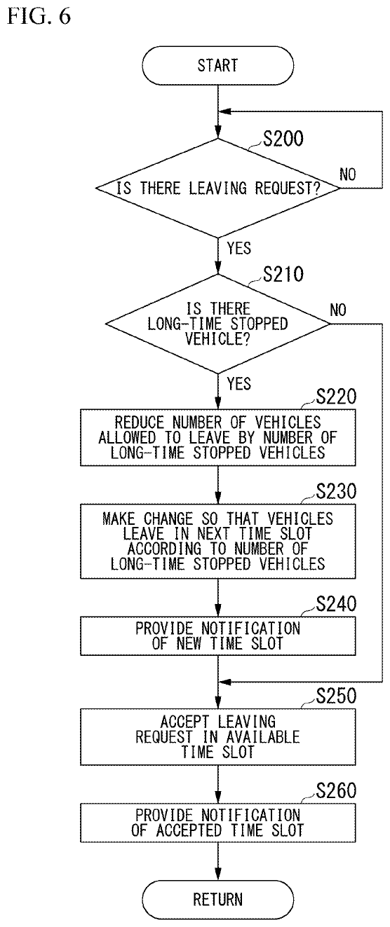

Hereinafter, a process of changing the time slot in which the leaving request has been accepted to be implemented by the acceptance unit 422 will be described. FIG. 6 is a flowchart showing an example of a flow of a process of changing a time slot in which a leaving request has been accepted to be executed by the acceptance unit 422. The acceptance unit 422 executes the process of changing the time slot in which the leaving request has been accepted when the leaving request has been received from any vehicle or when the recognizer 424 has recognized a long-time stopped vehicle. In the following description, the process of changing the time slot in which the leaving request has been accepted is assumed to be executed when a leaving request from any vehicle has been received.

The acceptance unit 422 checks whether or not there is a leaving request transmitted by any vehicle (step S200). When no leaving request has been transmitted from any vehicle in step S200, the acceptance unit 422 returns the process to step S200, and iteratively checks whether or not there is a leaving request transmitted by any vehicle at predetermined time intervals.

On the other hand, when there is a leaving request transmitted by any vehicle (hereinafter referred to as vehicle M) in step S200, the acceptance unit 422 checks whether or not the recognizer 424 has recognized the presence of the long-time stopped vehicle in the current stopping area 310 (step S210). When it is checked that there is no long-time stopped vehicle in the current stopping area 310 in step S210, the acceptance unit 422 moves the process to step S250.

On the other hand, when it is checked that the long-time stopped vehicle is present in the current stopping area 310 in step S210, the acceptance unit 422 reduces the number of vehicles allowed to leave in a latest time slot by the checked number of long-time stopped vehicles (step S220).

Next, the acceptance unit 422 makes a change so that vehicles whose leaving requests are accepted in the latest time slot and which are in a standby state for leaving leave in the next time slot according to the reduction in the number of vehicles in step S220 (step S230). At this time, the acceptance unit 422 sequentially moves (shifts) the vehicles in the standby state for leaving changed to leaving in the next time slot without changing the order of leaving. Then, the acceptance unit 422 notifies all vehicles whose time slot has been changed of information of a new time slot after the change (step S240).

Subsequently, the acceptance unit 422 accepts a currently received leaving request in an available time slot and assigns the leaving request to the accepted time slot (step S250). That is, the acceptance unit 422 assigns the currently received leaving request to a time slot in which the leaving request can be accepted. The acceptance unit 422 notifies the vehicle M transmitting the current leaving request of information of the time slot in which the leaving request has been accepted (step S260).

As described above, the acceptance unit 422 checks the stopping situation of vehicles in the stopping area 310 recognized by the recognizer 424 each time the leaving request transmitted by any vehicle is received and changes a time slot in which a vehicle whose leaving request has already been accepted leaves when there is a long-time stopped vehicle in the stopping area 310. Thereby, the acceptance unit 422 can eliminate a situation in which traffic congestion of leaving vehicles occurs in the stopping area 310 at an earlier stage. That is, the acceptance unit 422 can cause an appropriate number of vehicles to leave in accordance with a stopping situation of vehicles in the stopping area 310 assumed to change sequentially and allow the user to get into the vehicle in the stopping area 310 more smoothly.

The acceptance unit 422 iterates the processing of steps S210 to S240 if a process of changing a time slot in which a leaving request has been accepted is performed when the recognizer 424 has recognized the long-time stopped vehicle.

### [Parking Fee Calculation Process]

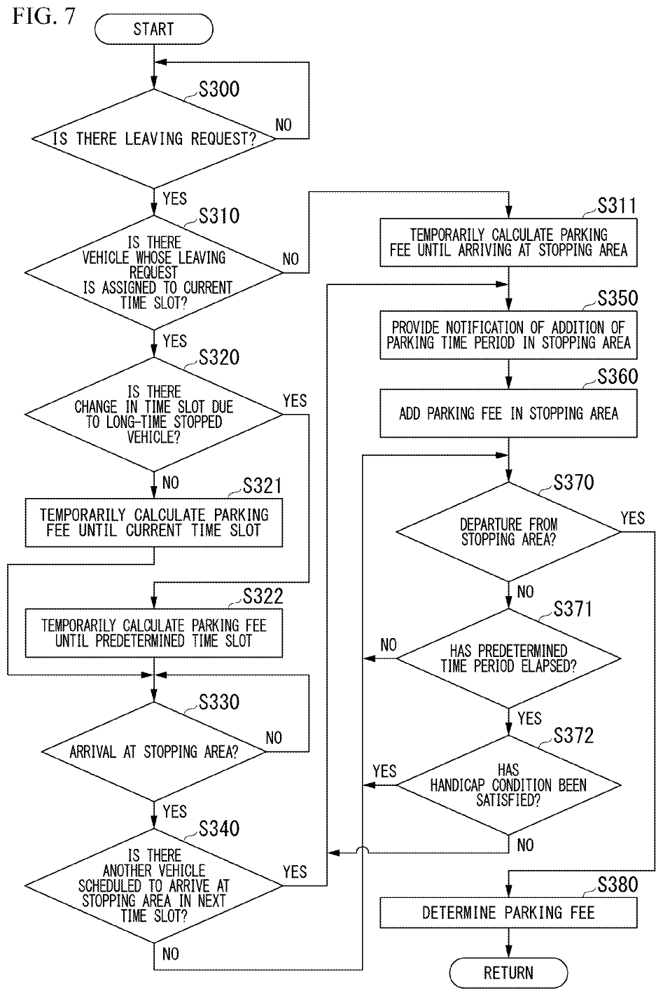

Hereinafter, a process of changing a target time period for calculating a parking fee to be implemented by the fee calculator 426 will be described. FIG. 7 is a flowchart showing an example of a flow of a process of changing a time period of a parking fee calculation target to be executed by the recognizer 424. The fee calculator 426 executes a parking fee calculation process from the time when the acceptance unit 422 receives a leaving request from any vehicle and the vehicle leaves.

The fee calculator 426 checks whether or not there is a leaving request received from any vehicle by the acceptance unit 422 (step S300). When the acceptance unit 422 has not received a leaving request from any vehicle in step S300, the fee calculator 426 returns the process to step S300 and iteratively checks the presence or absence of a leaving request received by the acceptance unit 422 at predetermined time intervals.

On the other hand, when there is a leaving request received from any vehicle by the acceptance unit 422 in step S300, the fee calculator 426 checks whether or not there is a leaving request from the vehicle to which the leaving request has been assigned to the current time slot by means of the acceptance unit 422 (step S310). When it is checked that there is no leaving request from the vehicle to which the leaving request has been assigned to the current time slot in step S310, the fee calculator 426 temporarily calculates a parking fee by setting a time period until the vehicle arrives at the stopping area 310 as a calculation target time period (step S311). Here, the vehicle whose leaving request has not been assigned to the current time slot for which the parking fee is temporarily calculated in step S311 includes, for example, a vehicle whose leaving is possible in the current time slot according to the immediate acceptance of a transmitted leaving request, a vehicle whose leaving request has been assigned to a previous time slot such as a previously reserved time slot and which is scheduled to leave in the current time slot due to a change in a schedule, and the like. Subsequently, the fee calculator 426 moves the process to step S350.

On the other hand, when it is checked that there is a leaving request from the vehicle whose leaving request has been assigned to the current time slot in step S310, the fee calculator 426 checks whether or not the time slot of the vehicle has been changed due to a long-time stopped vehicle (step S320). When it is checked that the time slot of the vehicle has not been changed by a long-time stopped vehicle in step S320, the fee calculator 426 temporarily calculates a parking fee by designating a time period until the current time slot (which may be a time period until the beginning time of the current time slot) as a calculation target time period (step S321). Subsequently, the fee calculator 426 moves the process to step S330.

On the other hand, when it is checked that the time slot of the vehicle has been changed due to a long-time stopped vehicle in step S320, the fee calculator 426 temporarily calculates a parking fee by designating a time period until a predetermined time slot to which the leaving request has been assigned (which may be a time period until the beginning time of the predetermined time slot) as a calculation target time period (step S322). Subsequently, the fee calculator 426 moves the process to step S330.

Next, the fee calculator 426 checks whether or not a leaving vehicle has arrived at the stopping area 310 in the current time slot, i.e., whether or not a leaving vehicle has been recognized by the recognizer 424 (step S330). When it is determined that the vehicle has not arrived at the stopping area 310 in step S330, the fee calculator 426 returns the process to step S330 and waits for the vehicle to arrive at the stopping area 310.

On the other hand, when it is checked that the vehicle has arrived at the stopping area 310 in step S330, the fee calculator 426 checks whether or not there is another vehicle scheduled to leave the parking space and arrive at the stopping area 310 in the next time slot by means of the acceptance unit 422 (step S340). That is, when the vehicle arriving and stopping at the stopping area 310 is a long-time stopped vehicle, the fee calculator 426 checks whether or not there is a possibility that congestion will occur in the stopping area 310. When it is checked that there is no other vehicle scheduled to leave the parking space and arrive at the stopping area 310 in the next time slot in step S340, the fee calculator 426 moves the process to step S370.

On the other hand, when it is checked that there is another vehicle scheduled to leave the parking space in the next time slot and arrive at the stopping area 310 in step S340, the fee calculator 426 notifies the vehicle arriving at the stopping area 310 that a current stop time period in the stopping area 310 is added to a time period of the parking fee calculation target (step S350). Thereby, the fee calculator 426 prompts the vehicle arriving at the stopping area 310 to early depart therefrom. Subsequently, the fee calculator 426 adds the parking fee according to the current stop time period in the stopping area 310 to the temporarily calculated parking fee (step S360).

Next, the fee calculator 426 checks whether or not the vehicle stopped in the stopping area 310 has departed from the stopping area 310, i.e., whether or not the movement of the vehicle from the stopping area 310 has been recognized, by means of the recognizer 424 (step S370). When it is checked that the vehicle stopped in the stopping area 310 has not departed therefrom, i.e., when the vehicle is continuously stopped in the stopping area 310, in step S370, the fee calculator 426 determines whether or not a predetermined time period (for example, 15 [min]) which is preset as a post-leaving stop time period in the stopping area 310 has elapsed (step S371). When it is determined that the predetermined time period has not elapsed in step S371, the fee calculator 426 returns the process to step S370 and iterates the checking of the departure of the vehicle and the determination of the elapse of the predetermined time period.

On the other hand, when it is determined that the predetermined time period has elapsed, i.e., when it is determined that the vehicle is a long-time stopped vehicle, in step S371, the fee calculator 426 checks whether or not the vehicle stopped in the stopping area 310 satisfies a handicap condition, i.e., whether or not the vehicle is a vehicle used by a user with a handicap (step S372). When it is checked that the handicap condition is satisfied in step S372, the fee calculator 426 returns the process to step S370, excludes the stop time period in the stopping area 310 (a post-leaving stop time period) from the time period of the parking fee calculation target, and waits for the vehicle to depart therefrom.

On the other hand, when it is checked that the handicap condition is not satisfied in step S372, the fee calculator 426 returns the process to step S350 and prompts the vehicle to early depart therefrom by providing a notification indicating that a stop time period in the stopping area 310 is added to a time period of the parking fee calculation target, adds the parking fee corresponding to the current stop time period to the temporarily calculated parking fee in step S360, and waits for the vehicle to depart therefrom.

On the other hand, when the departure of the vehicle stopped in the stopping area 310 can be checked in step S370, the fee calculator 426 determines the parking fee calculated so far (step S380).

In this manner, the fee calculator 426 changes the time period of the parking fee calculation target on the basis of a situation when each vehicle has left the parking space and a stopping situation after arriving at the stopping area 310. Thereby, the fee calculator 426 can calculate a parking fee considered to be fairer and allow the user to get into the vehicle in the stopping area 310 more smoothly.

[Example of Scene in which Change in Time Slot is Taken into Account]

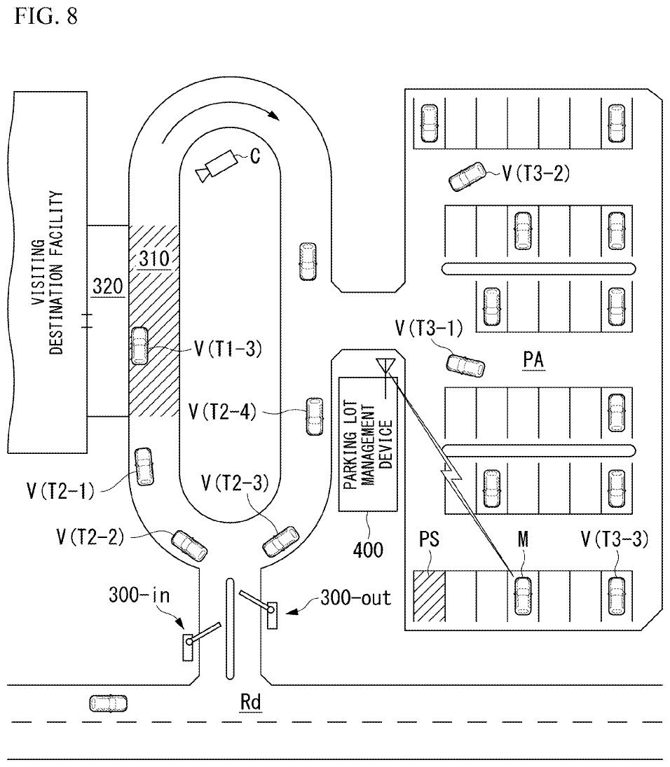

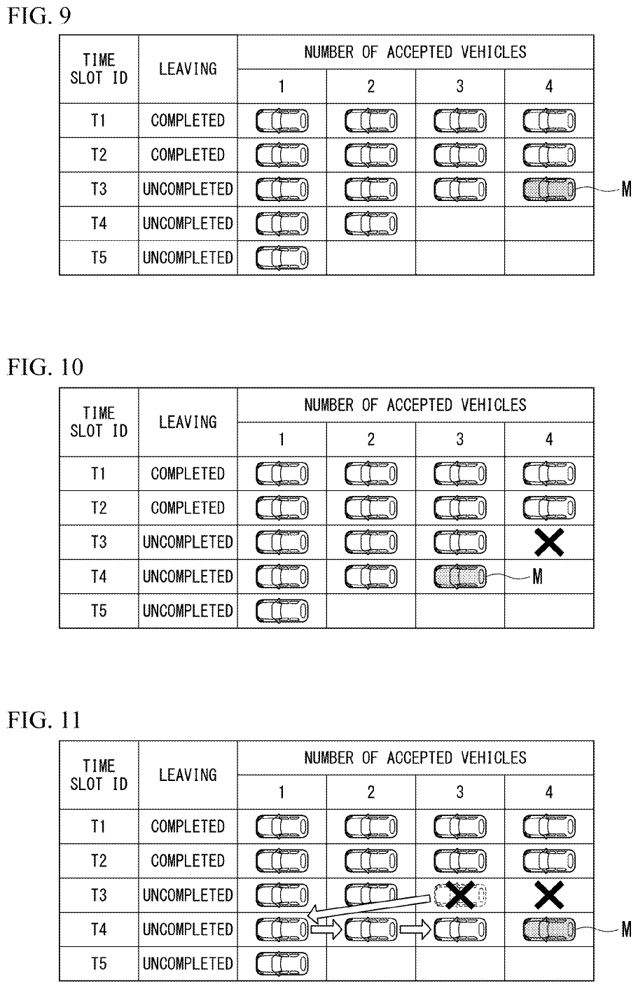

Hereinafter, a scene in which the acceptance unit 422 takes into account that a change in a time slot is required when a leaving request transmitted by the vehicle is accepted will be described with reference to FIGS. 8 to 11. FIG. 8 is a diagram schematically showing a scene in which it is necessary to change a time slot in which the acceptance unit 422 accepts a leaving request. FIG. 9 is a diagram showing an example of the leaving table 436 in which an accepted leaving request is assigned to a time slot. FIG. 10 is a diagram showing an example of the leaving table 436 in which a time slot for accepting a leaving request is changed according to the presence of a long-time stopped vehicle. FIG. 11 is a diagram showing an example of the leaving table 436 in which a time slot is changed according to the presence of a long-time stopped vehicle. In FIGS. 8 to 11, at the most, four vehicles are assumed to leave the parking space in each time slot.

The scene shown in FIG. 8 represents a state in which one vehicle V leaving the parking space at the time slot ID=T1 is stopped in the stopping area 310, four vehicles V leaving the parking space at the time slot ID=T2 travel toward the stopping area 310, and two vehicles V whose leaving requests have been accepted start movement for leaving at the time slot ID=T3. That is, the current time slot in the scene shown in FIG. 8 has the time slot ID=T3. In the scene shown in FIG. 8, the vehicle M parked in the parking lot PA is transmitting a leaving request to the parking lot management device 400. In FIG. 8, a time slot ID and an order in which the leaving request has been accepted in a time slot thereof are clearly shown within “( ): parentheses” following the reference sign of each vehicle V. For example, the vehicle V whose leaving request has been second accepted at the time slot ID=T2 is a vehicle V(T2−2).

In the scene shown in FIG. 8, when the acceptance unit 422 can immediately accept the leaving request transmitted by the vehicle M, the vehicle M can leave the parking space at the current time slot ID=T3. In this case, as shown in FIG. 9, the acceptance unit 422 stores the leaving request of the vehicle M at a fourth position of the time slot ID=T3 in the leaving table 436. The acceptance unit 422 notifies the vehicle M that the leaving request has been accepted at the fourth position of the time slot ID=T3. Thereby, the vehicle M starts movement for leaving after a vehicle V(T3−3) whose leaving request is accepted at a third position of the time slot ID=T3 starts movement for leaving.

Here, in the scene shown in FIG. 8, when the recognizer 424 recognizes that a vehicle V(T1−3) stopped in the stopping area 310 is a long-time stopped vehicle, the vehicle (T2−4) leaving the parking space at the time slot ID=T2 cannot be stopped in the stopping area 310 before the stopped vehicle V(T1−3) starts movement. Thus, as shown in FIG. 10, the acceptance unit 422 reduces the number of vehicles whose leaving requests are accepted at the current time slot=T3 of the leaving table 436. That is, the acceptance unit 422 does not perform the acceptance at the fourth position of the time slot ID=T3 in the leaving table 436. Subsequently, as shown in FIG. 10, the acceptance unit 422 accepts the leaving request transmitted by the vehicle M after the leaving request accepted at the next time slot ID=T4 of the leaving table 436, i.e., at a third position of the time slot ID=T4, and stores the accepted leaving request. The acceptance unit 422 notifies the vehicle M that the leaving request has been accepted at the third position of the time slot ID=T4. Thereby, the vehicle M starts movement for leaving after a vehicle V(T4−2) whose leaving request has been accepted at a second position of the time slot ID=T4 starts movement for leaving.

Alternatively, in the scene shown in FIG. 8, when the recognizer 424 recognizes that a vehicle V(T1−3) stopped in the stopping area 310 is a long-time stopped vehicle, the acceptance unit 422 changes a position of leaving of a vehicle V(T3−3) that has not started movement for leaving at the current time slot ID=T3 to a first position of the next time slot ID=T4. At the next time slot ID=T4, the order in which the vehicles V whose leaving requests have been accepted leave the parking space are sequentially moved (shifted) back. The leaving table 436 shown in FIG. 11 indicates that the vehicle V(T3−3) whose leaving request has been accepted at a third position of the time slot ID=T3 is moved to a first position of the time slot ID=T4, the vehicle V(T4−1) whose leaving request has been accepted at the first position of the time slot ID=T4 is moved (shifted) to a second position of the time slot ID=T4, and the vehicle V(T4−2) whose leaving request has been accepted at the second position of the time slot ID=T4 is moved (shifted) to a third position of the time slot ID=T4. The acceptance unit 422 notifies all vehicles (i.e., vehicles V(T3−3), V(T4−1), and V(T4−2)) whose time slots have been changed of information of new time slots after the change. Subsequently, as shown in FIG. 11, the acceptance unit 422 accepts the leaving request transmitted by the vehicle M at a fourth position of the time slot ID=T4 after moving the leaving request accepted at the next time slot ID=T4 of the leaving table 436 and stores the accepted leaving request. The acceptance unit 422 notifies the vehicle M that the leaving request has been accepted at the fourth position of the time slot ID=T4. Thereby, the vehicle M starts movement for leaving after the vehicle V(T4−3) whose leaving request has been accepted at a third position of the time slot ID=T4 starts movement for leaving.

The acceptance unit 422 may accept the leaving request transmitted by the vehicle M after the leaving request accepted at the next time slot ID=T5 of the leaving table 436, i.e., at a second position of the leaving frame ID=T5. In this case, the vehicle M starts movement for leaving after the vehicle V(T5−1) whose leaving request has been accepted at a first position of the time slot ID=T5 starts movement for leaving.

As described above, according to the parking lot management device 400 of the embodiment, the acceptance unit 422 adjusts the number of vehicles whose leaving requests are transmitted by the vehicles and accepted in each time slot in accordance with whether or not there is a long-time stopped vehicle in the stopping area 310 recognized by the recognizer 424 on the basis of images periodically transmitted by the camera C. According to the parking lot management device 400 of the embodiment, the fee calculator 426 changes a time period of a parking fee calculation target for a vehicle leaving the parking space on the basis of the accepted leaving request on the basis of a situation when the vehicle has left the parking space and a stopping situation after the vehicle arrives at the stopping area 310. Thereby, the parking lot management device 400 of the embodiment can eliminate a situation in which traffic congestion of leaving vehicles occurs in the stopping area 310, i.e., a platform, at an earlier stage and allow users to more smoothly get into their vehicles on the platform in the parking lot where a valet parking scheme is adopted.

An example in which the vehicle M receiving a pick-up request from the terminal device (the user terminal T) of the occupant transmits a leaving request to the parking lot management device 400 in response to the pick-up request in the parking lot management device 400 of the above-described embodiment has been described. However, the parking lot management device 400 of the embodiment can also directly receive the leaving request transmitted by the user terminal T. The operation in this case can be considered to be similar to an operation in the parking lot management device 400 of the above-described embodiment. Accordingly, in this case, the description of the process to be executed by the acceptance unit 422, the recognizer 424, and the fee calculator 426 is omitted.

### [Hardware Configuration]

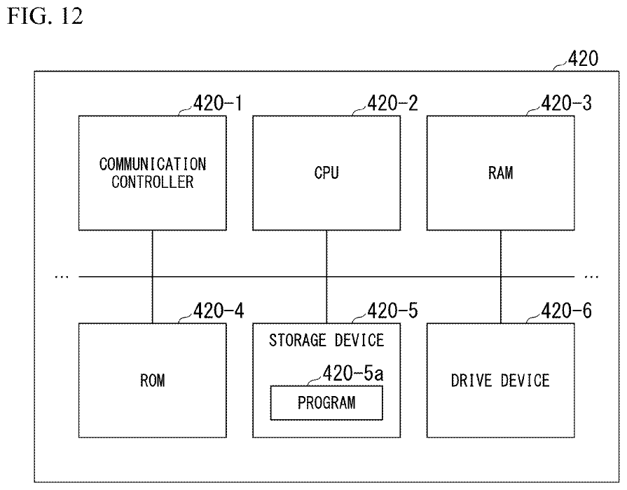

FIG. 12 is a diagram showing an example of a hardware configuration of the controller 420 according to the embodiment. As shown in FIG. 12, the controller 420 has a configuration in which a communication controller 420-1, a CPU 420-2, a random access memory (RAM) 420-3 used as a working memory, a read only memory (ROM) 420-4 storing a boot program and the like, a storage device 420-5 such as a flash memory or a hard disk drive (HDD), a drive device 420-6, and the like are mutually connected by an internal bus or a dedicated communication line. The communication controller 420-1 communicates with components other than the controller 420. The storage device 420-5 stores a program 420-5a to be executed by the CPU 420-2. This program is loaded to the RAM 420-3 by a direct memory access (DMA) controller (not shown) or the like and executed by the CPU 420-2. Thereby, some or all of the acceptance unit 422, the recognizer 424, and the fee calculator 426 are implemented.

The embodiment described above can be represented as follows.

A parking lot management device including:

a storage device storing a program; and

a hardware processor,

wherein the hardware processor executes the program stored in the storage device to:

accept leaving requests for requesting movement of vehicles parked in a parking lot to a stopping area for a predetermined number of vehicles in each time slot;

acquire information for recognizing a stopping situation of the vehicles in the stopping area and recognize the stopping situation of the vehicles in the stopping area on the basis of the acquired information; and

adjust the number of vehicles whose leaving requests are accepted in a subsequent time slot on the basis of whether or not the recognized situation of the stopping area indicates a tendency for vehicles to stop for a time period longer than a predetermined time period.

Although modes for carrying out the present invention have been described using embodiments, the present invention is not limited to the embodiments, and various modifications and substitutions can also be made without departing from the scope and spirit of the present invention.

What is claimed is:

1. A parking lot management device comprising:
an acceptance unit configured to accept leaving requests for requesting movement of vehicles parked in a parking lot to a stopping area for a predetermined number of vehicles in each time slot; and
a recognizer configured to acquire information for recognizing a stopping situation of the vehicles in the stopping area and recognize the stopping situation of the vehicles in the stopping area on the basis of the acquired information,
wherein the acceptance unit is configured to adjust the number of vehicles whose leaving requests are accepted in a subsequent time slot on the basis of whether or not the situation of the stopping area recognized by the recognizer indicates a tendency for vehicles to stop for a time period longer than a predetermined time period.

2. The parking lot management device according to claim 1,
wherein the recognizer is configured to measure a stop time period of each vehicle which is stopped in the stopping area, and
wherein the acceptance unit is configured to reduce the number of vehicles whose leaving requests are accepted in a subsequent time slot in a case where the recognizer has recognized the presence of a long-time stopped vehicle having a stop time period longer than the predetermined time period in a current time slot.

3. The parking lot management device according to claim 2,
wherein the recognizer is configured to measure a pre-entry stop time period in which each vehicle is stopped in the stopping area in a case where a user gets out of the vehicle, and
wherein the acceptance unit is configured to estimate the stop time period in which each vehicle is stopped in the stopping area after leaving the parking lot on the basis of the pre-entry stop time period and changes the number of vehicles whose leaving requests are accepted in each time slot on the basis of the estimated stop time period.

4. The parking lot management device according to claim 3,
wherein the acceptance unit is configured to provide a notification of a new time slot changed according to the recognition of the presence of the long-time stopped vehicle.

5. The parking lot management device according to claim 4, further comprising:
a fee calculator configured to calculate a parking fee in each vehicle,
wherein the fee calculator is configured to calculate the parking fee on the basis of a predetermined scheduled time when the vehicle arrives at the stopping area without including a delay time period in a time period of a parking fee calculation target in a case where a time at which the vehicle arrives at the stopping area according to the recognition of the presence of the long-time stopped vehicle has been delayed.

6. The parking lot management device according to claim 5,
wherein in a case where the vehicle after leaving has arrived at the stopping area the fee calculator includes the stop time period of the vehicle in the time period of the parking fee calculation target if another vehicle to be stopped in the stopping area is present in a subsequent time slot and does not include the stop time period of the vehicle in the time period of the parking fee calculation target if another vehicle to be stopped in the stopping area is absent in the subsequent time slot.

7. The parking lot management device according to claim 6,
wherein the fee calculator is configured to provide a notification of whether or not a current stop time period is to be included in the time period of the parking fee calculation target.

8. The parking lot management device according to claim 6,
wherein the fee calculator is configured to include a subsequent stop time period of the vehicle in the time period of the parking fee calculation target in a case where a current stop time period exceeds a predetermined time period.

9. The parking lot management device according to claim 8,
wherein the fee calculator is configured to exclude the subsequent stop time period of the vehicle from the time period of the parking fee calculation target in a case where the vehicle is a vehicle satisfying a handicap condition and the current stop time period exceeds the predetermined time period.

10. A parking lot management method using a computer comprising:
accepting leaving requests for requesting movement of vehicles parked in a parking lot to a stopping area for a predetermined number of vehicles in each time slot;
acquiring information for recognizing a stopping situation of the vehicles in the stopping area and recognizing the stopping situation of the vehicles in the stopping area on the basis of the acquired information; and
adjusting the number of vehicles whose leaving requests are accepted in a subsequent time slot on the basis of whether or not the recognized situation of the stopping area indicates a tendency for vehicles to stop for a time period longer than a predetermined time period.

11. A computer-readable non-transitory storage medium storing a program for causing a computer of a parking lot management device to:
accept leaving requests for requesting movement of vehicles parked in a parking lot to a stopping area for a predetermined number of vehicles in each time slot;
acquire information for recognizing a stopping situation of the vehicles in the stopping area and recognize the stopping situation of the vehicles in the stopping area on the basis of the acquired information; and
adjust the number of vehicles whose leaving requests are accepted in a subsequent time slot on the basis of whether or not the recognized situation of the stopping area indicates a tendency for vehicles to stop for a time period longer than a predetermined time period.
